(19) United States
(12) Patent Application Publication
(10) Pub. No.: US 2015/0105205 A1
(43) Pub. Date: Apr. 16, 2015

(54) DRIVE UNIT FOR VEHICLES

(71) Applicant: TOYOTA JIDOSHA KABUSHIKI KAISHA, Toyota-shi (JP)

(72) Inventors: Yuki KUROSAKI, Susono-shi (JP); Hiroyuki SHIOIRI, Yokohama-shi (JP); Hideaki KOMADA, Gotenba-shi (JP); Hiroyuki SHIBATA, Odawara-shi (JP); Hiroki YASUI, Susono-shi (JP); Hong Nam DANG, Susono-shi (JP)

(73) Assignee: TOYOTA JIDOSHA KABUSHIKI KAISHA, Toyota-shi (JP)

(21) Appl. No.: 14/514,663

(22) Filed: Oct. 15, 2014

(30) Foreign Application Priority Data
Oct. 15, 2013 (JP) 2013-215038
Aug. 6, 2014 (JP) 2014-160587

(51) Int. Cl. B60K 6/383; F16D 41/12; B60K 6/365

(52) U.S. Cl. CPC B60K 6/383; B60K 6/365; F16D 41/125; Y10S 903/91; Y10S 903/913
USPC 475/5; 192/45.1; 180/65.22; 903/910; 903/913

(57) ABSTRACT

A downsized drive unit for vehicles having an SOWC is provided. A motor 2 is held in a casing 31 opening toward an axially opposite side of the engine 1, and the opening 31a of the casing 31 is closed by a covering member 32. In order to selectively restrict any of forward and backward rotation of any of rotary members, the SOWC 8 is disposed coaxially with the motor 2 in an inner side of the covering member 32 and attached to the covering member 32.

The present invention claims the benefit of Japanese Patent Applications No. 2013-215038 filed on Oct. 15, 2013, and No. 2014-160587 filed on Aug. 6, 2014 with the Japanese Patent Office, the disclosures of which are incorporated herein by reference in its entirety.

### BACKGROUND

1. Field of the Invention

The present invention relates to the art of a device for generating a drive force to propel an automobile.

2. Discussion of the Related Art

In the conventional drive units for delivering a torque generated by a prime mover such as an engine and a motor to drive wheels, the torque and a speed of the prime mover are controlled according to need. JP-A-2013-67262 describes a hybrid drive unit in which a prime mover is comprised of an engine and two motors. In the drive unit taught by JP-A-2013-67262, the engine is connected to a power distribution device as a differential for distributing a power to an output member and to a first motor-generator. The output member is connected to a second motor-generator so that a torque thereof is controlled by the second motor-generator.

The drive unit taught by JP-A-2013-67262 is provided with a lock mechanism that selectively stops rotations of the engine and the first motor-generator. To this end, the lock mechanism is comprised of a sleeve splined to a first hub connected to the engine and to a second hub connected to the first motor-generator. Accordingly, the rotation of the engine or the first motor-generator is stopped by sliding the sleeve in an axial direction to spline to any one of those hubs, and the engine or the first motor-generator is allowed to rotate by placing the sleeve at a neutral position. In addition, in the drive unit taught by JP-A-2013-67262, the engine, the power distribution device, and the first motor-generator are arranged coaxially, and the lock mechanism is attached to a casing holding the power distribution device and the first motor-generator on an axially opposite side of the engine.

Specifically, in the drive unit taught by JP-A-2013-67262, the first and the second hubs are arranged coaxially, and the sleeve enclosing those hubs is engaged with an inner face of a casing while being allowed to slide axially but inhibited to rotate. In the casing, a fixing member is disposed adjacent to the first motor-generator, and an outer diameter of the casing at a fixing portion to be engaged with the sleeve is enlarged to hold the diametrically large first motor-generator. Therefore, an outer diameter of a fixing element of the lock mechanism or the lock mechanism itself has to be enlarged. For example, a selectable one-way clutch (to be abbreviated as “SOWC” hereinafter) may be used as the lock mechanism. However, if the SOWC is attached to the casing, the casing will be diametrically enlarged by the above-explained reasons.

The present invention has been conceived noting the foregoing technical problems, and it is therefore an object of the present invention is to downsize a drive unit for vehicles.

### SUMMARY OF THE INVENTION

The drive unit of the present invention is applied to a vehicle having an engine, a motor, and a differential connected to at least any one of the engine and the motor, in which a drive mode is switched by selectively stopping and allowing rotation of any of rotary members of the differential. The drive unit of the present invention is comprised of: a casing holding the motor and having an opening opening toward an axially opposite side of the engine; a covering member attached to the casing to close the opening; and a selectable one-way clutch that is engaged to restrict any of forward and backward rotations of said any of the rotary members, and that is disengaged to allow both forward and backward rotations of said any of the rotary members. In order to achieve the above-explained objective, according to the present invention, the selectable one-way clutch is disposed coaxially with the motor in an inner side of the covering member and attached to the covering member.

Specifically, the selectable one-way clutch is comprised of: a fixed clutch plate that is fixed to the covering member; a rotary clutch plate that is opposed to the fixed clutch plate while being allowed to rotate relatively therewith; an engagement piece that is held in the fixed clutch plate while being allowed to protrude toward the rotary clutch plate; and a recess that is engaged with the engagement piece protruded from the fixed clutch plate to restrict the rotary clutch plate from relative rotation in any of directions.

The selectable one-way clutch is further comprised of: a switching device that is adapted to allow the engagement piece to protrude toward the rotary clutch plate, and to disengage the engagement piece from the rotary clutch plate and confine the engagement piece in the fixed clutch plate; and an actuator for reciprocating the switching device that is attached to the covering member.

The above-mentioned differential is adapted to perform a differential action among a first rotary element connected with the engine, a second rotary member connected with the motor, and a third rotary element. Specifically, the aforementioned any one of directions is a rotational direction of the engine in a self-sustaining condition. In addition, the aforementioned any of rotary members includes a member integrated with an output shaft of the engine, and a rotary shaft of the motor or a member integrated with the rotary shaft.

The differential includes a first differential adapted to perform a differential action among the first rotary element connected with the engine, the second rotary element connected with the motor, and the third rotary element serving as an output element, and a second differential adapted to perform a differential action among a fourth rotary element connected with the engine, a fifth rotary element connected with the motor, and a sixth rotary element that is stopped selectively. The aforementioned any of rotary members further includes a member integrated with the sixth rotary element or a member integrated with the sixth rotary element.

As described, the differential is adapted to perform a differential action among a first rotary element connected with the engine, a second rotary element connected with the motor, and a third rotary element, and the aforementioned any one of directions is the rotational direction of the engine in a self-sustaining condition. According to another aspect of the present invention, the engagement piece includes a first engagement piece held in a first face of the fixed clutch plate, and a second engagement piece held in a second face of the fixed clutch plate. In this case, the selectable one-way clutch is provided with a first rotary clutch plate that is opposed to the first face and that has a first recess engaged with the first engagement piece, and a second rotary clutch plate that is opposed to the second face and that has a second recess engaged with the second engagement piece. Specifically, the first rotary clutch plate is connected with an output shaft of the engine or a member integrated with the output shaft, and the second rotary clutch plate is connected with a rotary shaft of the motor or a member integrated with the rotary shaft.

As also described, the differential includes the first differential adapted to perform a differential action among the first rotary element connected with the engine, the second rotary element connected with the motor, and the third rotary element serving as an output element, and the second differential adapted to perform a differential action among a fourth rotary element connected with the engine, a fifth rotary element connected with the motor, and a sixth rotary element that is stopped selectively. In addition, the selectable one-way clutch may be provided with the first engagement piece held in the first face of the fixed clutch plate, and a second engagement piece held in a second face of the fixed clutch plate. In this case, the selectable one-way clutch is further provided with a first rotary clutch plate that is opposed to the first face and that has a first recess engaged with the first engagement piece, and a second rotary clutch plate that is opposed to the second face and that has a second recess engaged with the second engagement piece. Specifically, the first rotary clutch plate is connected with an output shaft of the engine or a member integrated with the output shaft, and the second rotary clutch plate is connected with the sixth rotary element or a member integrated with the sixth rotary element.

In addition, the first engagement piece and the second engagement piece are displaced from each other in the radial direction of the fixed clutch plate.

Thus, according to the present invention, the selectable one-way clutch is attached to the covering member closing the casing. Specifically, the covering member extends radially around the center axis of the selectable one-way clutch, and the selectable one-way clutch can be attached to any appropriate portion of the inner face of the covering member. Therefore, an installation radius of the selectable one-way clutch can be reduced so that the drive unit can be downsized.

As described, the engagement piece of the selectable one-way clutch to be engaged with the rotary clutch plate is held in the fixed clutch plate fixed to the covering member. That is, the fixed clutch plate holding the engagement piece is not allowed to rotate so that the engagement piece can be manipulated as intended. In addition, a structure of the mechanism for actuating the engagement piece can be simplified.

To this end, the actuator for selectively actuating the engagement piece is also attached to the covering member. Therefore, heat of the actuator can be radiated through the covering member.

The drive mode of the drive unit can be selected from an engine mode and a motor mode. According to the present invention, the drive mode can be shifted between those modes easily by selectively restricting at least any of the engine and the motor connected to the differential from rotation by the selectable one-way clutch.

In addition, the engine speed can be lowered and increased by selectively restricting the sixth rotary element from rotation by the selectable one-way clutch. Thus, according to the present invention, the engine speed can be controlled easily using the selectable one-way clutch.

According to another aspect of the present invention, two selectable one-way clutches can be combined by arranging the engagement pieces on both faces of the common fixed clutch plate, and by situating the common fixed clutch plate between a pair of rotary clutch plates. Therefore, number of parts of the selectable one-way clutch can be reduced so that an installation radius of the selectable one-way clutch can be reduced. Consequently, the drive unit using the selectable one-way clutch can be downsized.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a cross-sectional view partially showing a first example of the drive unit according to the present invention;

FIG. 2 a skeleton diagram showing an entire structure of the drive unit shown in FIG. 1;

FIG. 3 is a cross-sectional view showing a structure of a selector plate type SOWC, in which FIG. 3 (a) shows the engaged SOWC, and in which FIG. 3 (b) shows the disengaged SOWC;

FIG. 4 a view schematically showing an example of actuating a strut through a pusher plate in the SOWC;

FIG. 5 a view schematically showing another example of actuating a strut through a pusher plate in the SOWC;

FIG. 6 a view showing an example of arrangement of an actuator for actuating the selector plate;

FIG. 7 is a view showing relative positions of rotational center axes of a first motor, a second motor, a counter shaft, a differential and so on;

FIG. 8 is a nomographic diagram of planetary gear units serving as a power distribution device and an overdrive device arranged in the drive unit shown in FIGS. 1 and 2;

FIG. 9 is a cross-sectional view partially showing a second example of the drive unit according to the present invention;

FIG. 10 a skeleton diagram showing an entire structure of the drive unit shown in FIG. 9;

FIG. 11 is a cross-sectional view showing a structure of the SOWC used in the second example, in which FIG. 1 (a) shows the engaged SOWC, and in which FIG. 11(b) shows the disengaged SOWC;

FIG. 12 is a nomographic diagram of planetary gear units serving as a power distribution device and an overdrive device arranged in the drive unit shown in FIGS. 9 and 10;

FIG. 13 is a cross-sectional view partially showing a third example of the drive unit according to the present invention;

FIG. 14 a skeleton diagram showing an entire structure of the drive unit shown in FIG. 13;

FIG. 15 is a nomographic diagram showing a status of a differential serving as a power distribution device under a hybrid mode and an overdrive mode of the drive unit shown in FIGS. 13 and 14;

FIG. 16 is a nomographic diagram showing a status of the differential serving as a power distribution device under a motor mode of the drive unit shown in FIGS. 13 and 14;

FIG. 17 is a cross-sectional view partially showing a fourth example of the drive unit according to the present invention; and

FIG. 18 a skeleton diagram showing an entire structure of the drive unit shown in FIG. 17.

### DETAILED DESCRIPTION OF THE PREFERRED EMBODIMENTS

### First Example

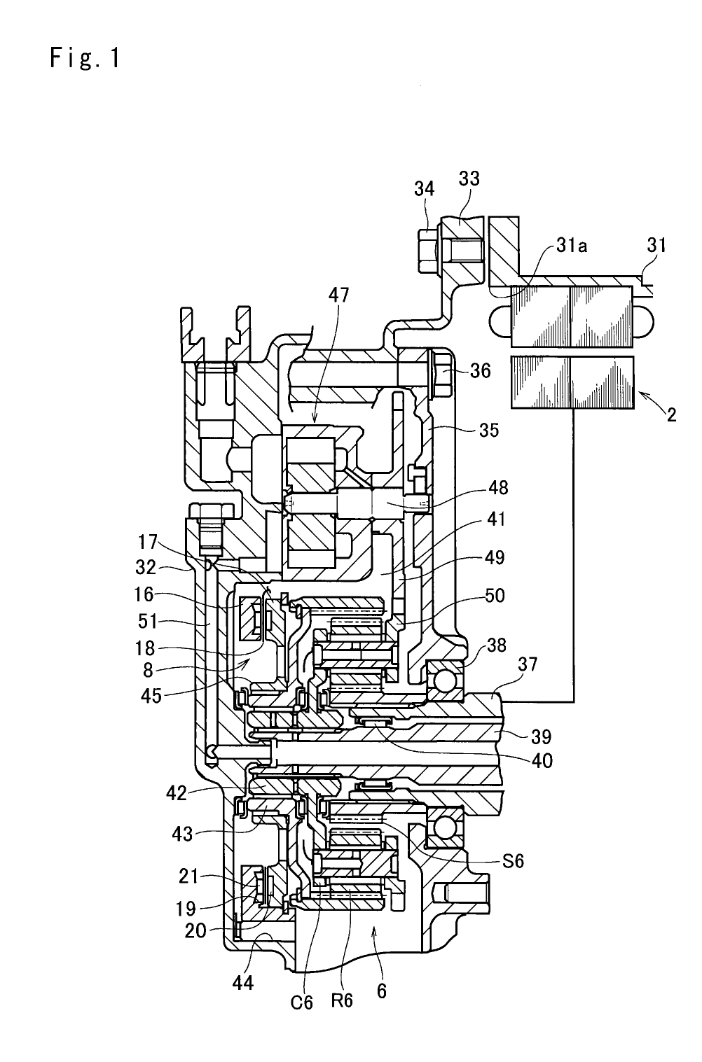

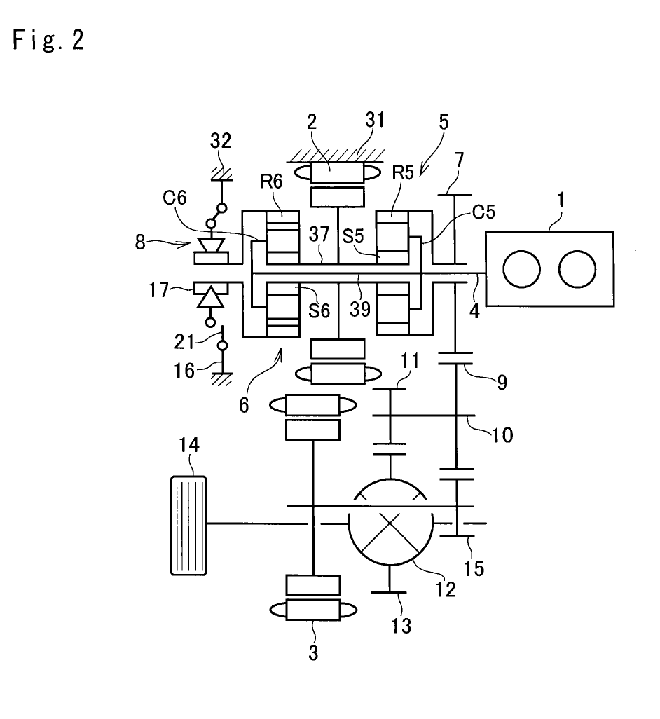

A cross-section of a drive unit according to a first example of the present invention is partially shown in FIG. 1, and an entire structure of the drive unit according to the first example is shown in FIG. 2. Referring now to FIG. 2, there is shown an example of applying the present invention to a hybrid drive unit of a front engine, front-wheel-drive (FF) layout. A prime move of the drive unit is comprised of an engine 1, a first motor-generator 2, and a second motor-generator 3. Those motors 2 and 3 will simply be called the “motor” in the following explanation. Here, the present invention may also be applied to a front engine, rear-wheel-drive (FR) layout.

A power distribution device 5, the first motor-generator 2, and an overdrive device (abbreviated as “O/D device” hereinafter) 6 are arranged coaxially on an output shaft (i.e., a crank shaft) 4 of the engine 1. In order to distribute an engine power to the first motor-generator 2 side and to the output side, a differential having three rotary elements is used as the power distribution device 5. Specifically, the differential employed in the example shown in FIG. 2 is a planetary gear unit comprised of a carrier C5 connected with the engine 1, a sun gear S5 connected with a rotor of the first motor-generator 2, and a ring gear R5 connected with a drive gear 7 serving as an output member. Accordingly, the carrier C5 serves as the first rotary element of the present invention, the sun gear S5 serves as the second rotary element of the present invention, and the ring gear R5 serves as an output element or the third rotary element of the present invention. Pinion gears are interposed between the sun gear S5 and the ring gear R5, and held by the carrier C5 while being allowed to rotate and revolve around the sun gear S5.

The O/D device 6 is adapted to change a rotational speed of the engine 1 with respect to a rotational speed of the drive gear 7. To this end, a differential having three rotary elements, specifically, a double pinion planetary gear unit is used as the O/D device 6. According to the example shown in FIG. 2, the O/D device 6 is comprised of a carrier C6 connected with the engine 1, a sun gear S6 connected with the rotor of the first motor-generator 2, a ring gear R6 as a fixing element connected with a selectable one-way clutch (abbreviated as “SOWC” hereinafter) 8, pinion gears meshing with the sun gear S6, and another pinion gears interposed between the pinion gears and the ring gear R6. Those pinion gears are held by the carrier C6 while being allowed to rotate and revolve around the sun gear S6. Accordingly, the carrier C6 serves as the fourth rotary element of the present invention, the sun gear S6 serves as the fifth rotary element of the present invention, and the ring gear R6 serves as the sixth rotary element of the present invention. The above-mentioned SOWC 8 will be explained later in more detail.

According to the first example, a predetermined rotary element of the power distribution device 5 is connected with a predetermined rotary element of the O/D device 6 to form a combined planetary gear unit. The combined planetary gear unit thus structured serves as the differential mechanism of the present invention.

A counter driven gear 9 is fitted onto one of end sides of a counter shaft 10 to be meshed with the drive gear 7, and a counter drive gear 11 that is diametrically smaller than the counter driven gear 9 is fitted onto the other end side of the counter shaft 10 to be meshed with a ring gear 13 of a differential 12. Therefore, the drive torque is delivered from the differential 12 to the drive wheels 14. A drive gear 15 that is diametrically smaller than the counter driven gear 9 is fitted onto a rotor shaft of the second motor-generator 3 to be meshed with the counter driven gear 9. That is, the drive gear 15 and the counter driven gear 9 serve as a speed reduction mechanism.

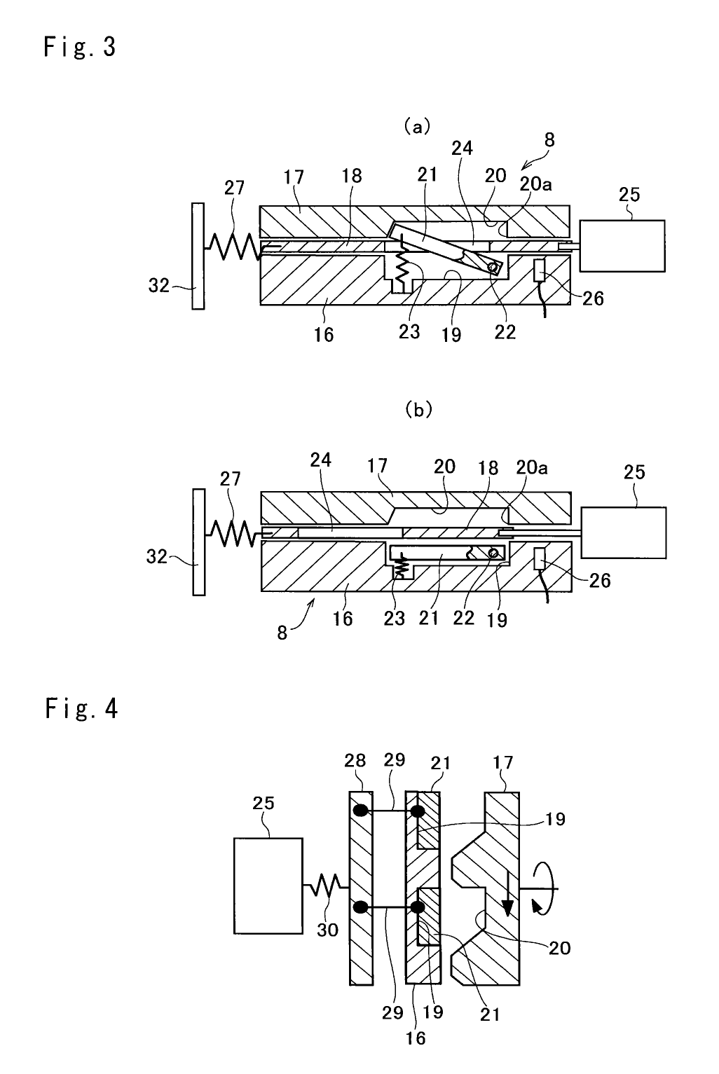

Here will be explained a structure of the SOWC 8. For example, the SOWC taught by JP-A-2012-224148, the SOWC taught by U.S. publication 2010/0252384 etc. may be used in the drive unit according to the present invention. Referring now to FIG. 3, there is shown a cross-section of the selector plate type SOWC 8 used in the present invention. As shown in FIG. 3, a pocket plate 16 and a notch plate 17 are being opposed to each other on a common rotational axis, and the notch plate 17 is allowed to rotate relatively with the pocket plate 16. Both of the pocket plate 16 and the notch plate 17 are circular plate members, and a selector plate 18 is interposed therebetween while being allowed to rotate relatively with those plates 16 and 17. Accordingly, the pocket plate 16 serves as the fixed clutch plate of the present invention, and the notch plate 17 serves as the rotary clutch plate of the present invention.

A plurality of pockets 19 as a depression extending in a rotational direction are formed in a circular manner on radially outer portion of the pocket plate 16, and a plurality of notches 20 having a same configuration as the pocket 19 is formed on the notch plate 17 at a radial position to be opposed to the pocket 19. An engagement piece (as will be called a “strut” hereinafter) 21 whose cross section is substantially congruent with a configuration of the pocket 19 is held in each pocket 19, and the strut 21 is allowed to pivot around a pin 22 radially penetrating through one of end portions of the strut 21. That is, the strut 21 is allowed not only to be housed in the pocket 19, but also to pivot around the pin 21 thereby protruding the other end portion from the pocket 19. To this end, a spring for elastically pushing the other end portion of the strut 21 toward the notch plate 17 is individually interposed in each clearance between the strut 21 and the pocket plate 16. Therefore, the strut 21 is pushed into the pocket 19 by an external force against the elastic force of the spring 23.

Specifically, the notches 20 are also formed in a circular manner on radially outer portion of the notch plate 17 at the radial position to be opposed individually to the pockets 19. Therefore, given that a torque is applied to the SOWC 8 to rotate the notch plate 17 in a direction that said one of the end portions of the strut 21 being pushed up by the spring 23 butts against an inner wall of the notch 20, a relative rotation (or a differential rotation) between the pocket plate 16 and the notch plate 17 is restricted by the strut 21. That is, the SOWC 8 is engaged. By contrast, given that the torque is applied to the SOWC 8 to rotate the notch plate 17 in the opposite direction, an upper face of the strut 21 is pushed into the pocket 19 by an edge 20a of the notch 20. Consequently, the notch plate 17 is disengaged from the strut 21 of the pocket plate 16 so that the notch plate 17 is allowed to rotate relatively with respect to the pocket plate 16. In other words, a differential rotation of the notch plate 17 in a negative direction is allowed. Thus, the SOWC 8 is adapted to serve as a one-way clutch.

The selector plate 18 is an annular plate member having a plurality of through holes 24 formed in a circular manner at same positions as the pockets 19 and the notches 20. Therefore, the strut 21 held in the pocket 19 is allowed to enter into the notch 20 through the through hole 24.

A position of the selector plate 18 is shifted between a position (shown in FIG. 3 (a)) where the through hole 24 is aligned with the pocket 19 to allow the strut 21 to enter into the notch 20, and a position (shown in FIG. 3 (b)) where the through hole 24 is displaced from the pocket 19 to confine the strut 21 in the pocket 19. To this end, the SOWC 8 is provided with an actuator 25 for shifting the selector plate 18 between those positions. For example, a hydraulic cylinder, a direct operated motor or the like may be used as the actuator 25. In order to detect a stroke of the actuator 25 and a position of the selector plate 18, the SOWC 8 is further provided with a sensor 26. For example, an on-off sensor or a stroke sensor adapted detect a displacement of an object may be used as the sensor 26.

Provided that a single-acting actuator adapted to generate a pulling force is employed as the actuator 25, a return spring 27 is interposed between a predetermined fixing member and the selector plate 18 to pull the selector plate 18 against the pulling force of the actuator 25. Therefore, if the actuator 25 is turned off so that the selector plate 18 is released from the pulling force of the actuator 25, the selector plate 18 is elastically pulled by the return spring 27 to the position shown in FIG. 3 (b) while pushing the strut 21 into the pocket 19. In this case, therefore, the SOWC 8 is disengaged. By contrast, if the actuator 25 is turned on, the selector plate 18 is pulled by the pulling force of the actuator 25 to the position shown in FIG. 3 (a) so that the SOWC 8 is engaged. Accordingly, the selector plate 18 serves as the switching device of the present invention.

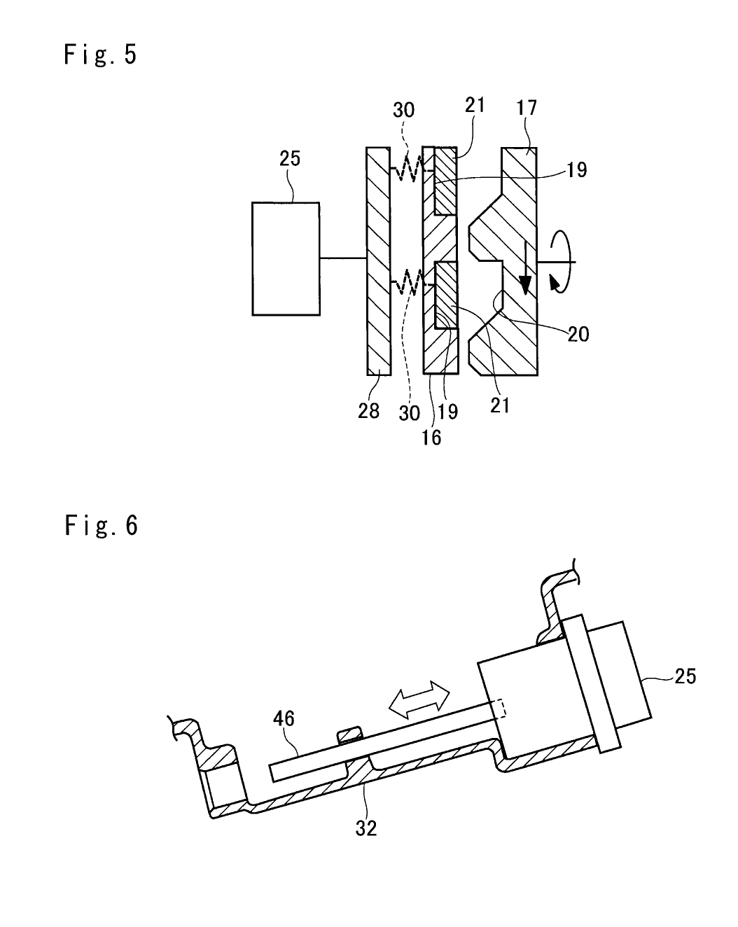

Alternatively, in the SOWC 8, the strut 21 may also be actuated directly without using the selector plate 18. An example of the SOWC 8 in which the strut 21 is actuated without using the selector plate 18 is shown in FIGS. 4 and 5. According to the example shown in FIG. 4, a pusher plate 28 is arranged behind the pocket plate 16 (i.e., on an opposite side of the notch plate 17), and the pusher plate 28 is reciprocated toward and away from the pocket plate 16 by the actuator 25. One of faces of the pusher plate 28 is connected with each strut 21 through a pin (or rod) 29 penetrating through the pocket plate 16, and the other face of the pusher plate 28 is connected with the actuator 25 through a spring 30. Therefore, the strut 21 is pushed out of the pocket 19 by the pusher plate 19 through the pin 29, and a backward movement of the strut 21 toward the pocket 19 is elastically allowed by the spring 30. Thus, the SOWC 8 shown in FIG. 4 also serves as the one-way clutch. According to the example shown in FIG. 5, one of faces the pusher plate 28 is connected with each strut 21 through a spring 30, and the other face of the pusher plate 28 is connected with the actuator 25. Thus, in any of those examples shown in FIGS. 4 and 5, each strut 21 is allowed to protrude toward the notch plate 17 and to be pushed into the pocket 19 by the actuator 25. In addition, since the spring is interposed between the actuator 25 and the strut 21, the SOWC 8 shown in FIG. 5 is also allowed to serve as the one-way clutch. Accordingly, the pusher plate 28, the actuator 25, the pin 29 and the spring 30 also serve as the switching mechanism of the present invention.

As shown in FIG. 2, the SOWC 8 is arranged coaxially with the engine 1 across the power distribution device 5, the first motor-generator 2, and the O/D device 6. Such arrangement of the SOWC 8 is illustrated in FIG. 1 in more detail. The power distribution device 5, the first motor-generator 2, the drive gear 7 and the counter driven gear 9 meshing therewith and so on are held in a casing 31. The casing 31 is opened on both ends in the common axial direction of the power distribution device 5, the first motor-generator 2 etc., and one of the openings of the casing 31 in the engine 1 side is closed by connecting the engine 1 thereto. The other opening 31a of the casing 31 in the SOWC 8 side is closed by an end cover 32 having a flange 33 on its outer circumferential portion, and the end cover 32 is fixed to the casing 31 by a bolt 34 penetrating through the flange 33.

A portion of the casing 31 in a slightly inner circumferential side is protruded outwardly to create a recess inside of the protruded portion, and a center support 35 as a plate member is attached to an opening end of the recess oriented to an inner space of the casing 31 by a bolt 36. A rotor shaft 37 integrated with the rotor of the first motor-generator 2 penetrates through the center support 35 while being supported by a bearing 38 interposed therebetween. The rotor shaft 37 is a hollow shaft, and an input shaft 39 integrated with the output shaft 4 of the engine 1 is inserted into the rotor shaft 37. In addition, a bearing 40 is interposed between an outer circumferential face of the input shaft 39 and an inner circumferential face of the rotor shaft 37 to provide a relative rotation therebetween. An end portion of the input shaft 39 protrudes from the rotor shaft 37 to the vicinity of an inner face of the end cover 32. Thus, the center support 35 closes an internal space of the end cover 32 to form a chamber 41.

The above-explained O/D device 6 and the SOWC 8 are held in the chamber 41 thus formed. Specifically, the sun gear S6 of the O/D device 6 is splined onto a leading end of the rotor shaft 37 inserted into the chamber 41. The carrier C6 has a boss 42 splined onto the input shaft 39 protruding from the rotor shaft 37, that is, the carrier C6 is connected with the engine 1. The ring gear R6 is connected with a radially outer end of a flange of a boss 43 fitted onto the boss 42 of the carrier C6 while being allowed to rotate relatively therewith. In order to selectively stop the rotation of the ring gear R6 in a predetermined direction (i.e., in the forward direction), the SOWC 8 is connected with the boss 43 connected with the ring gear R6. Here, according to the present invention, a definition of the term “forward direction” is a rotational direction of the engine 1 in a self-sustaining condition.

A cylindrical chamber 44 is formed inside of the end cover 32 around the input shaft 39, and the SOWC 8 is held in the cylindrical chamber 44. As described, the SOWC 8 is comprised of the pocket plate 16, the notch plate 17 and the selector plate 18, and an outer diameter of the SOWC 8 is substantially identical to that of the O/D device 6. According to the first example shown in FIG. 1, the notch plate 17 is situated adjacent to the O/D device 6, and the pocket plate 16 is situated adjacent to the inner wall of the end cover 32. However, the axial positions of the pocket plate 16 and the notch plate 17 may be switched according to need. An outer circumferential face of the pocket plate 16 is splined with an inner circumferential face of the cylindrical chamber 44 to be fixed to the end cover 32, and a boss 45 integrally formed in an inner circumferential side of the notch plate 17 is splined onto the boss 43 connected with the ring gear R6 so that the notch plate 17 is connected with the ring gear R6.

The cylindrical chamber 44 extends in the axial direction of the input shaft 39, and an actuator 25 for actuating the selector plate 18 is attached to an outer face of the cylindrical chamber 44. Referring now to FIG. 6, there is shown the actuator 25 in more detail. Specifically, a solenoid actuator actuated electro-magnetically to generate a reciprocating force is used as the actuator 25. The actuator 25 is comprised of a plunger 46 arranged on the outer face of the end cover 32 while being allowed to reciprocate in parallel with a tangent line of the SOWC 8. In order to radiate heat of the actuator 25, a terminal of the actuator 25 is partially exposed on the outside of the end cover 32. Although not especially shown in FIG. 6, the plunger 46 is connected to one of connecting portions of the selector plate 18 protruding toward the outer circumferential side, and the return spring 27 is connected to other connecting portion of the selector plate 18. Here, the return spring 27 may be arranged not only inside but also outside of the end cover 32.

As shown in FIG. 1, according to the first example of the present invention, the SOWC 8 is arranged inside of the end cover 32 and attached thereto. That is, a radial position of an installation portion to which the SOWC 8 is attached may fall within a designed radial position of the cylindrical chamber 44 serving as the installation portion. Therefore, an installation radius of the SOWC 8 may be reduced in comparison with that of a case in which the SOWC 8 is attached to an inner face of the casing 31. That is, the drive unit can be downsized. In addition, the pocket plate 16 supporting the strut 21 is fixed to the end cover 32. Therefore, the strut 21 will not be subjected to centrifugal force so that the strut 21 is allowed to be stably protruded toward the notch plate 17 and withdrawn into the pocket 19.

In order to deliver lubricant and to generate hydraulic pressure, an oil pump 47 is also disposed in the chamber 41 in parallel with the O/D device 6 and the SOWC 8. For example, a gear pump, a vane pump, a radial piston pump etc. adapted to generate hydraulic pressure by a rotation of a rotor or a gear may be used as the oil pump 47, and a gear 49 is fitted onto a rotary shaft 48 of the oil pump 47. The gear 49 is meshed with a gear 50 attached to the carrier C6 of the O/D device 6 so as to drive the oil pump 47 by a power of the engine 1. In addition, a suction port, a discharging port, and an oil passage connected with those ports are formed in the end cover 32. Specifically, a discharging passage 51 extends from the oil pump 47 to a leading end of the input shaft 39 while penetrating through the end cover 32. The input shaft 39 is also a hollow shaft in which an oil passage is formed along a rotational center axis thereof, and the leading end of the input shaft 39 is engaged with a protrusion of the end cover 32 thereby connecting the oil passage formed therein with the discharging passage 51.

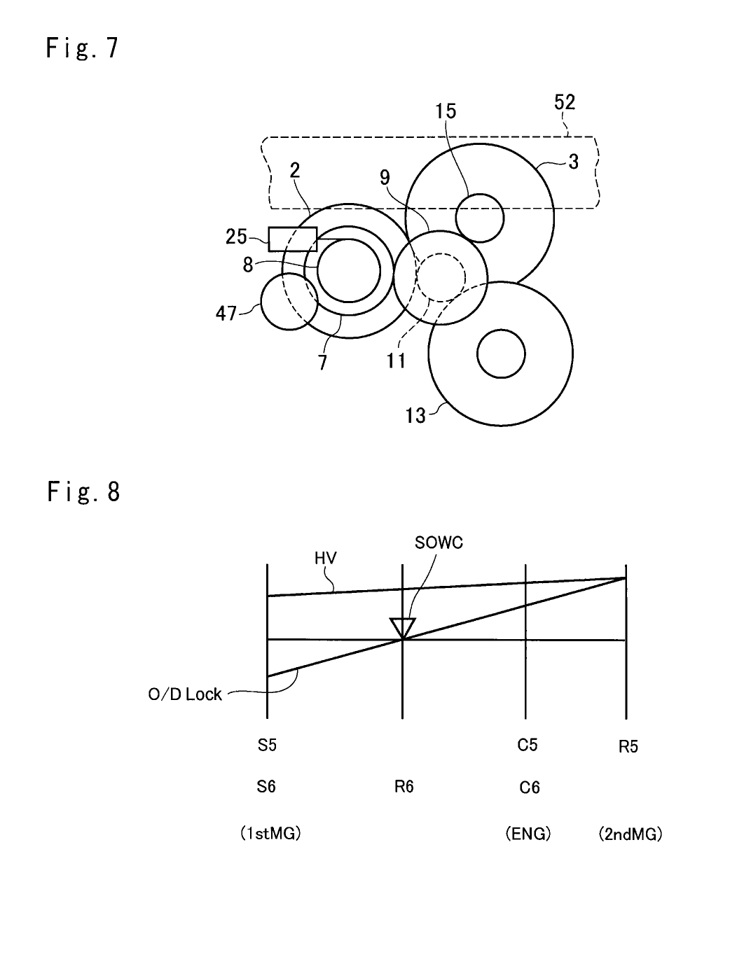

Since the O/D device 6 and the SOWC 8 are thus held in the chamber 41 formed by axially expanding the end cover 32, an axial length of the drive unit is elongated according to an axial dimension of the chamber 41. However, mountability of the drive unit on a vehicle is still improved by the reason to be explained hereinafter. FIG. 7 is a view showing relative positions of rotational center axes of the first motor-generator 2, the second motor-generator 3, the counter shaft 10, the differential 12 etc. As described, the differential 12 is connected to the drive wheels 14, therefore, the differential 12 is situated at relatively lower level in a height direction of the vehicle. The counter drive gear 11 transmitting the drive force to the differential 12, and the counter shaft 10 on which the counter drive gear 11 is mounted are situated above the differential 12 while being displaced from the differential 12 in a longitudinal direction of the vehicle. The input shaft 39 and the rotary members arranged coaxially therewith are situated at a substantially same level as the counter shaft 10 while being displaced therefrom in the longitudinal direction of the vehicle. The second motor-generator 3 is situated substantially above the differential 12 at a higher level than the counter shaft 10.

Accordingly, the cylindrical chamber 44 holding the SOWC 8 therein is situated at a lower level than the second motor-generator 3. That is, the cylindrical chamber 44 holding the SOWC 8, the actuator 25, and the oil pump 47 are situated below a side member 52 of the vehicle body. Thus, even if the axial length of the vehicle is elongated by attaching the SOWC 8, the actuator 25, and the oil pump 47 to the end cover 32, those members are situated underneath the side member 52 so that the mountability of the drive unit itself will not be worsened.

Here will be explained a drive mode of the drive unit shown in FIG. 2. FIG. 8 is a nomographic diagram of the power distribution device 5 and the O/D device 6. In FIG. 8, the line represented as “HV” indicates a driving condition achieved by disengaging the SOWC 8. As explained with reference to FIG. 3 (b), the SOWC 8 is disengaged by pushing the strut 21 being engaged with the notch 20 into the pocket 19 by the selector plate 18. Consequently, the notch plate 17 and the ring gear R6 connected therewith are allowed to rotate in both forward (i.e., the rotational direction of the engine 1) and backward directions. In this situation, a negative torque is applied to the ring gear R5 according to a running resistance of the vehicle, and a positive torque is applied to the carrier C5 according to an output torque of the engine 1. Under the situation shown in FIG. 8, the first motor-generator 2 being rotated in the forward direction is operated as a generator to apply a negative torque to the sun gear S5 so as to control the speed of the engine 1 in accordance with the speed of the first motor-generator 2 in a fuel efficient manner. An electric power generated by the first motor-generator 2 is delivered to the second motor-generator 3 thereby operating the second motor-generator 3 as a motor. Thus, the power of the engine 1 is distributed to the drive gear 7 side and to the first motor-generator 2 side. The power delivered to the first motor-generator 2 is once converted into the electric power, and then converted into a mechanical power again by the second motor-generator 3 and added to the power distributed to the drive gear 7 side. That is, the drive mode of the vehicle is shifted to a hybrid mode by disengaging the SOWC 8.

In FIG. 8, the line represented as “O/D lock” indicates a driving condition achieved by engaging the SOWC 8 as shown in FIG. 3 (a), and in this case, the ring gear R6 of the O/D device 6 is restricted from forward rotation. In this situation, specifically, the carrier C6 is rotated in the forward direction while restricting a forward rotation of the ring gear R6 so that the sun gear S6 is rotated in the backward direction. Since the sun gear S6 is connected with the sun gear S5 of the power distribution device 5, the carrier C5 of the power distribution device 5 is rotated by the torque of the engine 1 in the forward direction while rotating the sun gear S5 in the backward direction. Consequently, the ring gear R5 functioning as the output element is rotated in the forward direction at a speed higher than that of the carrier C5. That is, the engine speed of this case is reduced to be lower than that under the hybrid mode so that a substantial speed ratio is reduced to be smaller than “1”. As a result, the drive mode is shifted to an overdrive mode.

### Second Example

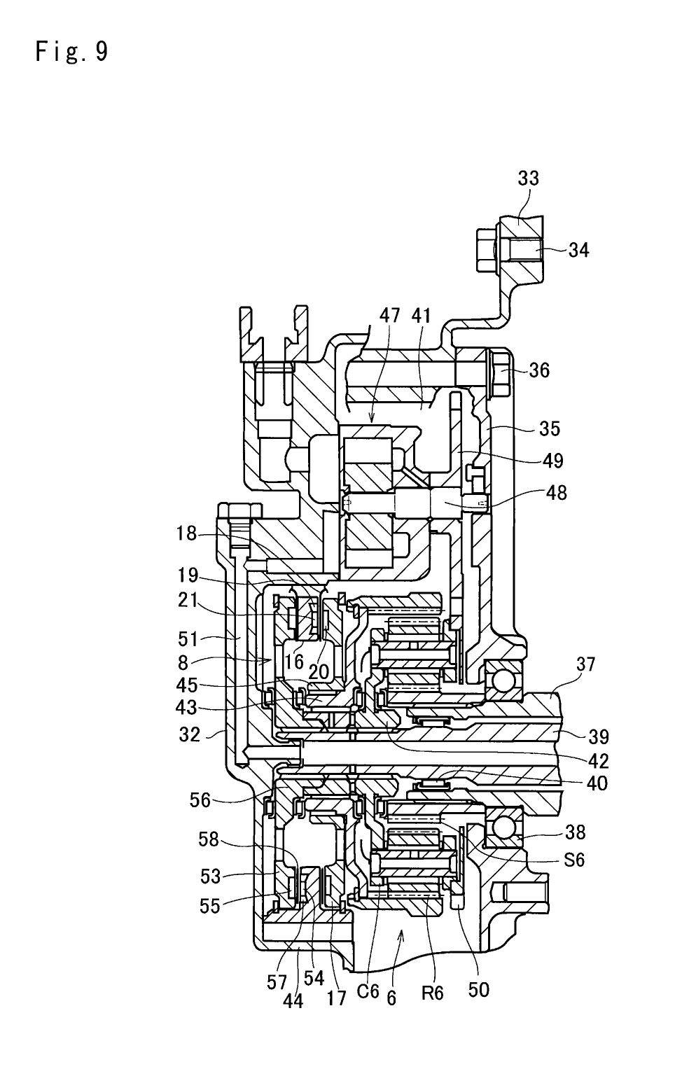

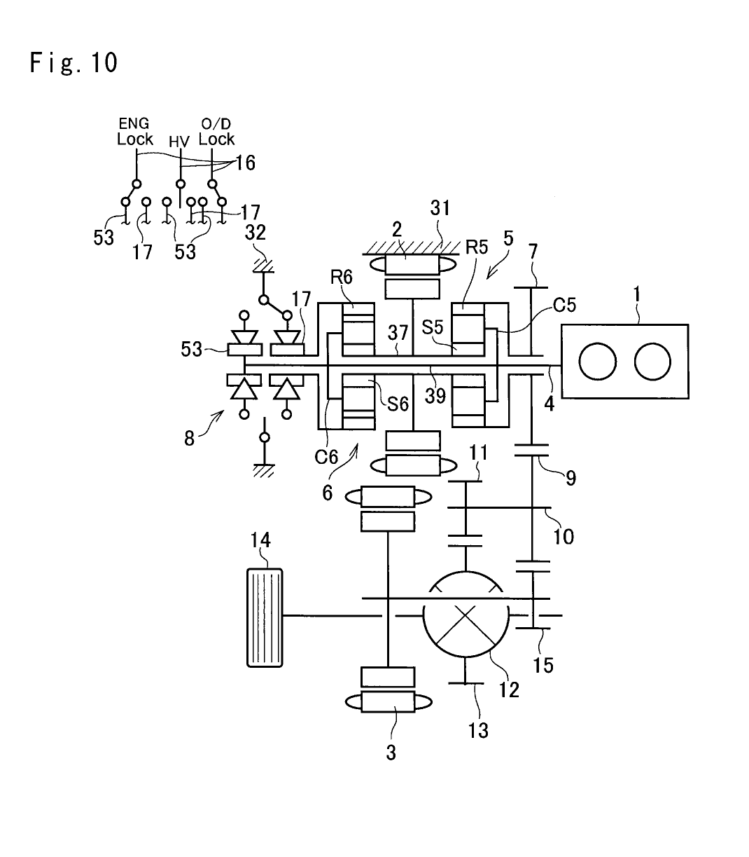

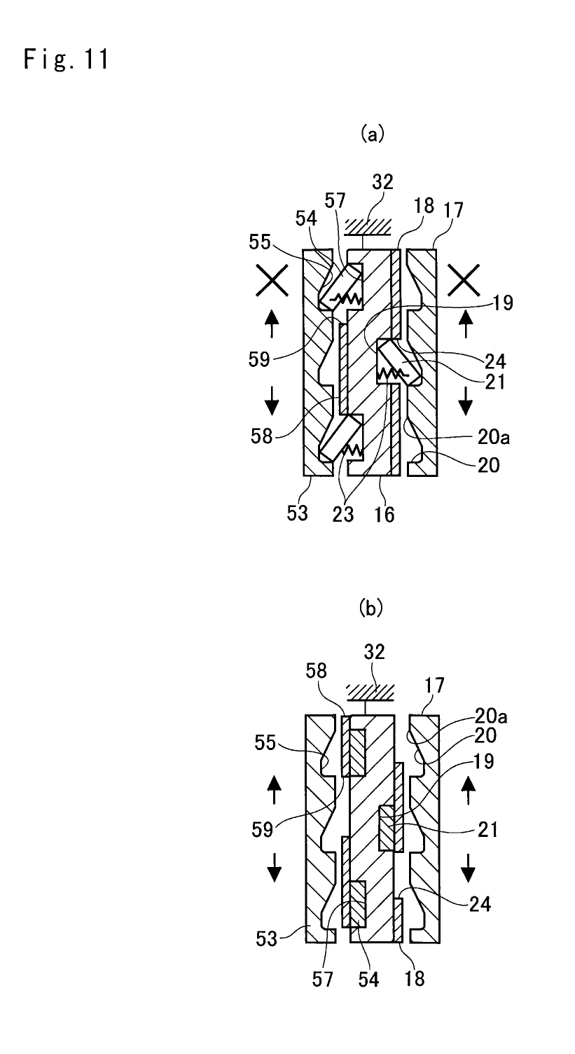

Thus, the drive unit according to the first example of the present invention is adapted to restrict the forward rotation of the ring gear R6 of the O/D device 6 by the SOWC 8. According to the present invention, the drive unit may be modified to also restrict the rotation of the engine 1 by the SOWC 8. A cross-section of the drive unit according to the second example is partially shown in FIG. 9, and an entire structure thereof is schematically shown in FIG. 10. Here, the elements of the second example identical to those in the first example are represented by the common reference numerals, and detailed explanation thereof will be omitted. According to the second example, as shown in FIGS. 9 and 10, the SOWC 8 is provided with a second notch plate 53 connected with the input shaft 39, and a second strut 54 selectively engaged with the second notch plate 53, in addition to the first notch plate 17 (i.e., the first rotary clutch plate of the invention). A structure of the SOWC 8 according to the second example is shown in FIG. 11. The second notch plate 53 is also a circular plate member having notches 55 individually formed in the same configuration as the notch 20 (i.e., the first recess of the invention) of the first notch plate 17 while being opposed to the pocket plate 16. Specifically, the second notch plate 53 is disposed between the pocket plate 16 and the end cover 32. As described, the input shaft 39 protrudes from the bosses 42, 43 and 45 toward the end cover 32, and a boss 56 integrated with the second notch plate 53 is splined onto the leading end of the input shaft 39. That is, the second notch plate 53 is connected to the engine 1 through the input shaft 39. Accordingly, the second notch plate 53 serves as the second rotary clutch plate of the invention, the second strut 54 serves as the second engagement piece of the invention, and the notch 55 serves as the second recess of the invention.

The second strut 54 has a same configuration as the strut 21 (i.e., the first engagement piece of the invention) to be engaged with the first notch plate 17, and the second strut 54 is held in a second pocket 57 formed on a second face of the pocket plate 16 opposed to the second notch plate 53. Although not especially shown in FIG. 11, the second strut 54 is also allowed to pivot around a pin radially penetrating through one of end portions thereof, and pushed toward the second notch plate 53 by an elastic member as the aforementioned spring 23.

According to the second example, the pocket 57 holding the second strut 54 is formed on the second face of the pocket plate 16 while being displaced radially from the pocket 19 holding the first strut 21 formed on a first face of the pocket plate 16 in the radial direction. That is, the pockets 16 and 57 are not formed at radially same level on both sides of the pocket plate 16 so that a thickness of the pocket plate 16 is not reduced excessively locally. Therefore, a thickness of the pocket plate 16 is still can be reduced to a certain extent without weakening strength of the pocket plate 16 significantly. In other words, the SOWC can be downsized by reducing the thickness of the pocket plate 16.

In addition, a second selector plate 58 having a same configuration as the aforementioned selector plate 18 is interposed between the second notch plate 53 and the pocket plate 16. Specifically, through holes 59 are also formed in the second selector plate 58 at same positions as the pockets 57 and the notches 55. In order to reciprocate the second selector plate 58 along the pocket plate 16, another actuators similar to the aforementioned actuator 25 and the spring 30 may be arranged in the second example. Alternatively, the selector plates 18 and 58 may also be actuated individually by a common actuator.

Thus, according to the example shown in FIG. 11, the common pocket plate 16 is shared by the SOWC for stopping the forward rotation (represented by “X” in FIG. 11) of the first notch plate 17, and the SOWC for stopping the forward rotation of the second notch plate 53. Therefore, number of parts of the SOWC 8 can be reduced so that the drive unit using the SOWC 8 can be downsized.

In the drive unit according to the second example shown in FIGS. 9 to 11, the drive mode can be shifted among the hybrid mode, the overdrive mode, and a motor mode. For example, the hybrid mode is achieved by pushing both of the struts 21 and 54 into the pockets 19 and 57 thereby allowing the ring gear R6 and the engine 1 to rotate in the forward direction. The overdrive mode is achieved by engaging the first strut 21 with the notch 20 of the first notch plate 17. As the first example, under the overdrive mode, the first notch plate 17 and the ring gear R6 connected therewith are restricted from forward rotation. Accordingly, the operating states of the power distribution device 5 and the O/D device 6 under the hybrid mode and the overdrive mode may also be expressed as those in the nomographic diagram shown in FIG. 8.

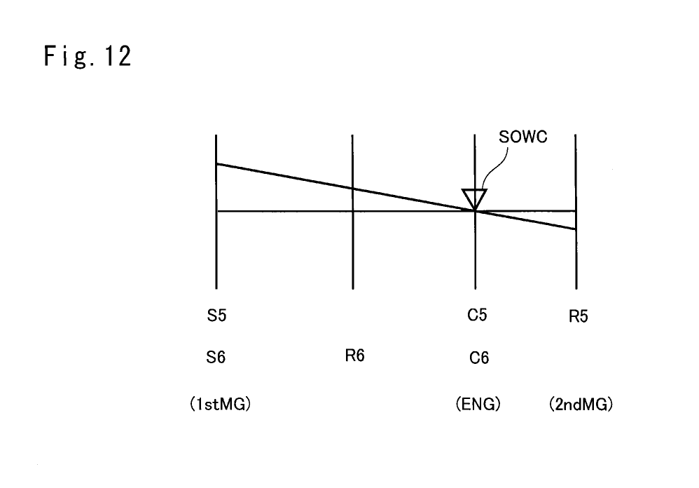

In turn, the motor mode is achieved by engaging the second strut 54 with the notch 55 of the second notch plate 53 thereby restricting the second notch plate 53, and the input shaft 39 and the engine 1 connected therewith from forward rotation. In this situation, the engine 1 is stopped and the vehicle is powered by at least one of the first and the second motor-generators 2 and 3. The operating states of the power distribution device 5 and the O/D device 6 under the motor mode are indicated in the nomographic diagram shown in FIG. 12. Specifically, FIG. 12 shows a situation in which the vehicle is propelled backwardly. In this situation, the first motor-generator 2 outputs a forward torque, and the torque of the first motor-generator 2 is applied to the ring gear R5 of the power distribution device 5 in the negative direction. Meanwhile, a negative torque generated by the second motor-generator 3 is added to the torque of the ring gear R5. In addition, the vehicle is also allowed to be propelled in the forward direction by operating the second motor-generator 3 to generate the forward torque.

The operating states of the SOWC 8 under each drive mode is shown in FIGS. 10 and 11. In FIG. 10, “HV” represents the operating state of the SOWC 8 to establish the hybrid mode, and such operating state is also illustrated in FIG. 11 (b). In turn, “O/D lock” in FIG. 10 represents the operating state of the SOWC 8 to establish the overdrive mode, and such operating state is also illustrated in the right side of FIG. 11 (a). Further, “ENG lock” in FIG. 10 represents the operating state of the SOWC 8 to establish the motor mode, and such operating state is also illustrated in the left side of FIG. 11 (a). In FIG. 11 (a), although both of the struts 21 and 54 are engaged with the notches 20 and 55 for the sake of illustration, those struts 21 and 54 will not be engaged simultaneously while the vehicle is in motion.

Thus, the SOWC 8 is also attached to the end cover 32 in the drive unit according to the second example shown in FIGS. 9 to 12. Therefore, the drive unit according to the second example may also be downsized to improve the mountability thereof.

### Third Example

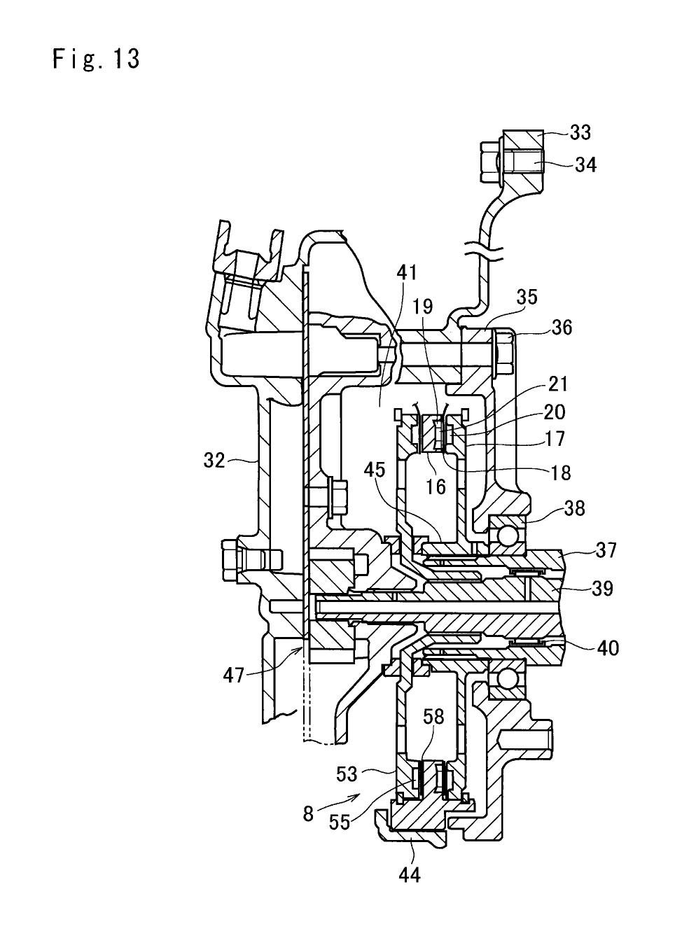

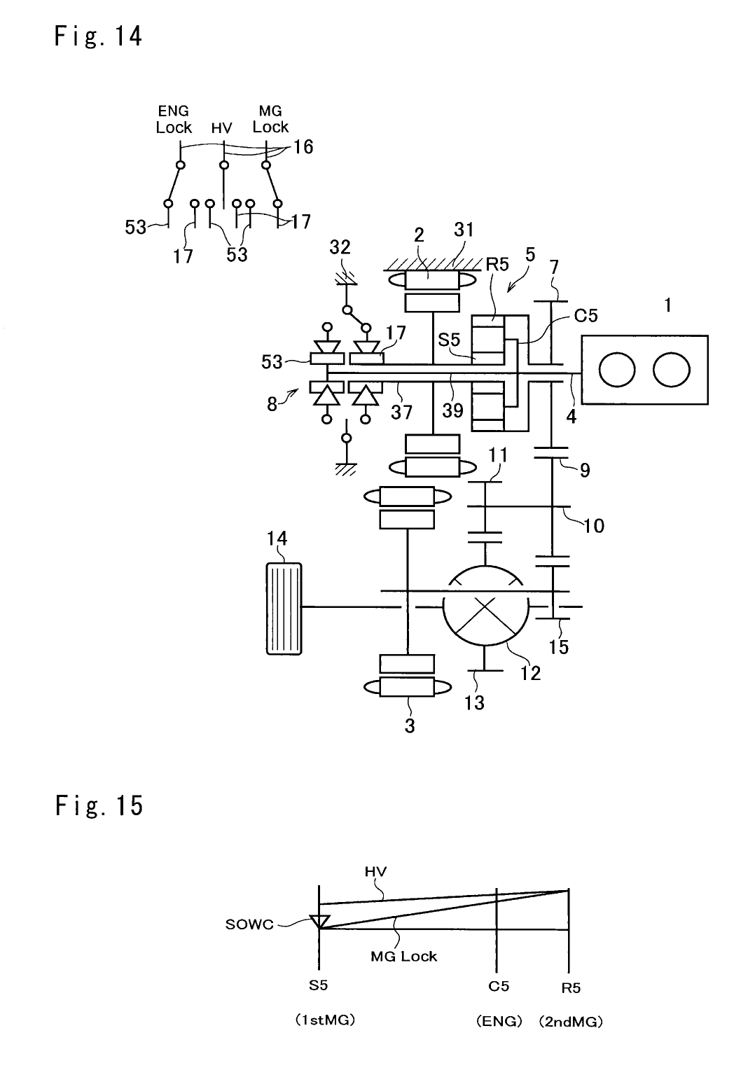

The present invention may also be applied to the drive unit without having the O/D device 6. Accordingly, in the third example, the power distribution device 5 corresponds to the “differential” of the present invention. A cross-section of the drive unit according to the third example is partially shown in FIG. 13, and an entire structure thereof is schematically shown in FIG. 14. Here, the elements of the third example identical to those in the first and the second examples are represented by the common reference numerals, and detailed explanation thereof will be omitted. According to the third example, as shown in FIG. 14, the SOWC 8 shown in FIGS. 9 and 10 is disposed coaxially with the engine 1 across the power distribution device 5. Referring to FIG. 13, the rotor shaft 37 and the input shaft 39 extend to an inner space of the chamber 41 formed by the end cover 32 and the center support 35, and the first notch plate 17 is fitted onto the rotor shaft 37 through the boss 45. The second notch plate 53 is integrated with the cylindrical boss 56, and an end portion of the boss 56 is interposed between the inner circumferential face of the rotor shaft 37 and the outer circumferential face of the input shaft 39 to be splined with the input shaft 39. That is, the second notch plate 53 is connected to the engine 1 through the input shaft 39. The pocket plate 16 is interposed between the notch plates 17 and 53, and an outer circumferential end of the pocket plate 16 is splined with the inner circumferential face of the end cover 32.

As shown in FIG. 13, the oil pump 47 is arranged coaxially with the SOWC 8 and attached to the inner wall of the end cover 32. The leading end of the input shaft 39 is inserted into the oil pump 47 to be connected with a gear or a rotor of the oil pump 47 so as to drive the oil pump 47 by a power of the engine 1.

Since the drive unit according to the third example shown in FIGS. 13 and 14 is provided with the SOWC 8 according to the second example shown in FIGS. 9 and 10, the drive mode of the drive unit according to the third example may also be shifted among the three modes. As described, the hybrid mode is achieved by pushing both of the struts 21 and 54 into the pockets 19 and 57 by the selector plates 18 and 58 thereby disengaging the SOWC 8. The operating state of the SOWC 8 to establish the hybrid mode is represented by “HV” in FIG. 14, and also illustrated in FIG. 11 (b). An operating state of the power distribution device 5 under the hybrid mode of the drive unit according to the third example is indicated in the nomographic diagram shown in FIG. 15. As indicated by the line represented by “HV”, under the hybrid mode, the carrier C5 is rotated in the forward direction by the torque of the engine 1, and the sun gear S5 is rotated by the first motor-generator 2. In this situation, the engine speed can be controlled according to the speed of the first motor-generator 2 by operating the first motor-generator 2 as a generator while rotating in the forward direction to apply the negative torque to the ring gear R5. An electric power generated by the first motor-generator 2 is delivered to the second motor-generator 3 thereby operating the second motor-generator 3 as a motor to generate a drive force.

The motor mode is selected to power the vehicle by the first and the second motor-generators 2 and 3 while stopping the engine 1. To this end, as the second example, the motor mode is established by engaging the second strut 54 with the notch 55 of the second notch plate 53. The operating state of the SOWC 8 establishing the motor mode is represented by “ENG lock” in FIG. 14, and such operating state is also illustrated in the left side of FIG. 11 (a).

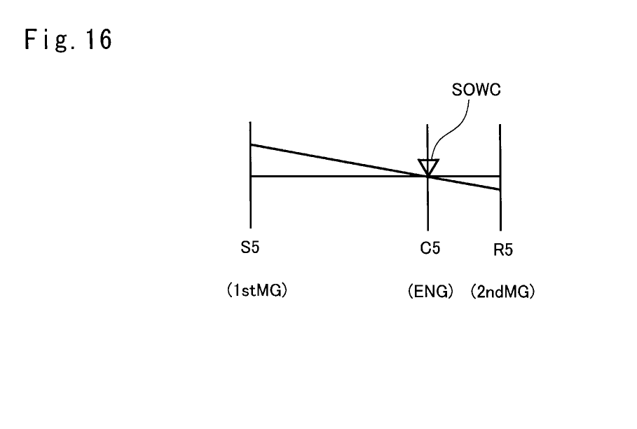

Under the motor mode, the second notch plate 53, and the input shaft 39 and the engine 1 connected therewith are restricted from forward rotation. That is, the engine 1 is stopped and the vehicle is powered by at least one of the first and the second motor-generators 2 and 3. The operating state of the power distribution device 5 under the motor mode is indicated in the nomographic diagram shown in FIG. 16. Specifically, FIG. 16 shows a situation in which the vehicle is propelled backwardly. In this situation, the first motor-generator 2 outputs a forward torque, and the torque of the first motor-generator 2 is applied to the ring gear R5 of the power distribution device 5 in the negative direction. Meanwhile, a negative torque generated by the second motor-generator 3 is added to the torque of the ring gear R5. In addition, the vehicle is also allowed to be propelled in the forward direction by operating the second motor-generator 3 to generate the forward torque.

According to the third example, a motor lock mode is achieved by engaging the first strut 21 with the notch 20 of the first notch plate 17 thereby restricting the first motor-generator 2 from the forward rotation. The operating state of the SOWC 8 establishing the motor lock mode is represented by “MG lock” in FIG. 14, and such operating state is also illustrated in the right side of FIG. 11 (a). When the carrier C5 connected with the first notch plate 17 is rotated in the forward direction by the torque of the engine 1, a forward torque is applied to the sun gear S5. In this situation, the forward rotation of the sun gear S5 can be stopped by engaging the first strut 21 of the SOWC 8 with the first notch plate 17. Consequently, the ring gear R5 as the output element is rotated in the forward direction at a speed higher than that of the carrier C5 (i.e., higher than the rotational speed of the engine 1), as indicated by the line represented by “MG lock” in FIG. 15. Thus, under the motor lock mode, the vehicle is powered by the engine 1, and the ring gear R5 as the output element is rotated at higher speed than the rotational speed of engine 1. That is, under the motor lock mode, the vehicle is propelled under the overdrive condition where the speed ratio is smaller than “1”.

Thus, the SOWC 8 is also attached to the end cover 32 in the drive unit according to the third example shown in FIGS. 13 to 16. Therefore, the drive unit according to the third example may also be downsized to improve the mountability thereof.

### Fourth Example

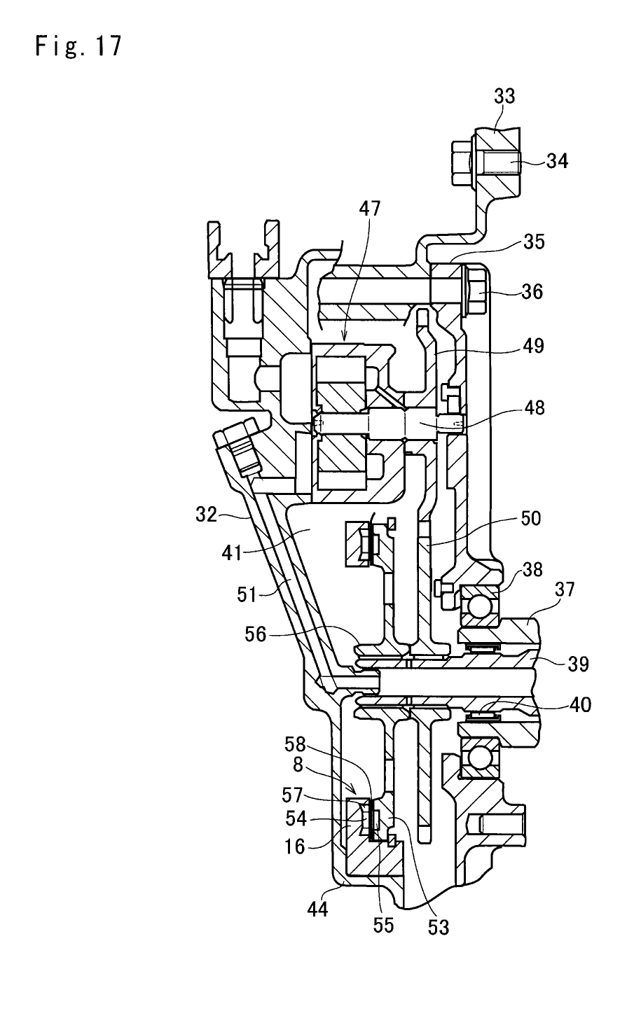

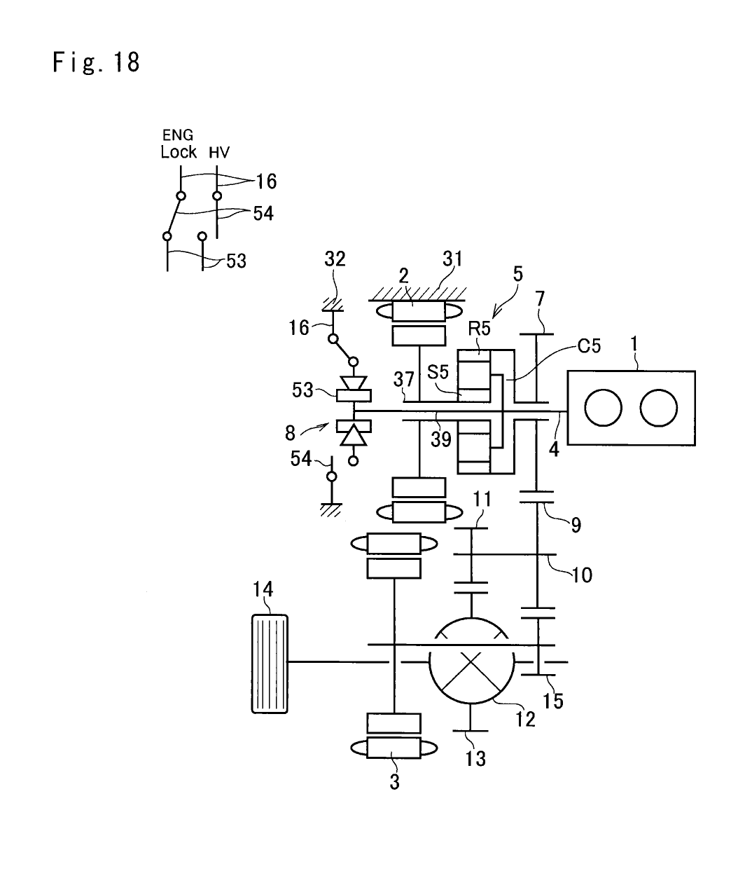

The present invention may also be applied to the drive unit adapted to shift the drive mode between the hybrid mode and the motor mode. A cross-section of the drive unit according to the fourth example is partially shown in FIG. 17, and an entire structure thereof is schematically shown in FIG. 18. Here, the elements of the fourth example identical to those in the first to the third examples are represented by the common reference numerals, and detailed explanation thereof will be omitted. According to the fourth example, as shown in FIGS. 17 and 18, the SOWC 8 is provided only with the second notch plate 53. That is, the SOWC 8 does not have the first notch plate 17. As the foregoing examples, the second notch plate 53 is fitted onto the input shaft 39 so that the rotation of the engine 1 is restricted by the SOWC 8.

Specifically, as shown in FIG. 17, the leading end of the rotor shaft 37 is inserted into the bearing 38 without extending into the chamber 41. On the other hand, the input shaft 39 extends into the chamber 41 so that the leading end thereof is inserted into the boss 56 of the second notch plate 53 to be splined therewith at the vicinity of the inner face of the end cover 32. According to the fourth example shown in FIG. 17, the second notch plate 53 is situated closer to the engine 1 (or the center support 35) than the pocket plate 16. Also, the oil pump 47 is arranged in the chamber 41 in parallel with the SOWC 8. Specifically, the gear 49 is fitted onto the rotary shaft 48 of the oil pump 47, and the gear 50 meshing with the gear 49 is fitted onto the input shaft 39 to be rotated integrally therewith.

Operating states of the SOWC 8 of the fourth example under the hybrid mode and the motor mode are similar to those of the second and the third examples. Specifically, the hybrid mode (represented by “HV” in FIG. 18) is established by pushing the second strut 54 into the pocket 57 by the second selector plate 18 thereby allowing the input shaft 39 and the engine 1 connected therewith to rotate freely. By contrast, the input shaft 39 (or engine 1) is restricted from forward rotation by engaging the second strut 54 with the second notch plate 53. In this situation, the vehicle is propelled in the backward direction by rotating the first motor-generator 2 in the forward direction while rotating the second motor-generator 3 in the backward direction. That is, the vehicle is propelled under the motor mode indicated in FIG. 16. Here, the engagement states of the SOWC 8 under the motor mode can be illustrated by reversing the left half of FIG. 11 (a).

It is understood that the invention is not limited by the exact construction of the foregoing first to fourth examples, but that various modifications may be made without departing from the scope of the inventions. For example, positions of the first notch plate 17 and the second notch plate 53 may be switched according to need. In addition, the actuator 25 may be displaced radially outwardly from the coaxial position with the SOWC 8 shown in FIGS. 4 and 5 to actuate the SOWC 8 along the tangent line thereof. In this case, an optional cam or linkage mechanism may be employed to change a direction of action of the actuator 25 in a manner such that the reciprocating force acts along the axial direction of the SOWC 8. Moreover, the installation configuration of the actuator 25 illustrated in FIG. 6 may also be applied to the second to the fourth examples. Further, it is also possible to use a double-pinion planetary gear unit as the power distribution device 5, and to use a single-pinion planetary gear unit as the O/D device.

What is claimed is:

1. A drive unit for a vehicle having an engine, a motor, and a differential connected to at least any one of the engine and the motor, in which a drive mode is switched by selectively stopping and allowing rotation of any of rotary members of the differential, comprising:
a casing holding the motor and having an opening opening toward an axially opposite side of the engine;
a covering member that is attached to the casing to close the opening;
a selectable one-way clutch that is engaged to restrict any one of forward and backward rotations of said any of the rotary members, and that is disengaged to allow both forward and backward rotations of said any of the rotary members;
wherein the selectable one-way clutch is disposed coaxially with the motor in an inner side of the covering member and attached to the covering member.

2. The drive unit for a vehicle as claimed in claim 1, wherein the selectable one-way clutch is comprised of:
a fixed clutch plate that is fixed to the covering member;
a rotary clutch plate that is opposed to the fixed clutch plate while being allowed to rotate relatively therewith;
an engagement piece that is held in the fixed clutch plate while being allowed to protrude toward the rotary clutch plate; and
a recess that is engaged with the engagement piece protruded from the fixed clutch plate to restrict the rotary clutch plate from relative rotation in said any one of directions.

3. The drive unit for a vehicle as claimed in claim 2, wherein the selectable one-way clutch is further comprised of:
a switching device that is adapted to allow the engagement piece to protrude toward the rotary clutch plate, and to disengage the engagement piece from the rotary clutch plate and confine the engagement piece in the fixed clutch plate; and
an actuator for reciprocating the switching device that is attached to the covering member.

4. The drive unit for a vehicle as claimed in claim 1,
wherein the differential is adapted to perform a differential action among a first rotary element connected with the engine, a second rotary element connected with the motor, and a third rotary element;
wherein said any one of directions includes a rotational direction of the engine in a self-sustaining condition; and
wherein said any of rotary members includes a member integrated with an output shaft of the engine, and a rotary shaft of the motor or a member integrated with the rotary shaft.

5. The drive unit for a vehicle as claimed in claim 1,
wherein the differential includes
a first differential adapted to perform a differential action among the first rotary element connected with the engine, the second rotary element connected with the motor, and the third rotary element serving as an output element, and
a second differential adapted to perform a differential action among a fourth rotary element connected with the engine, a fifth rotary element connected with the motor, and a sixth rotary element that is stopped selectively; and
wherein said any of rotary members includes a member integrated with the sixth rotary element or a member integrated with the sixth rotary element.

6. The drive unit for a vehicle as claimed in claim 2,
wherein the differential is adapted to perform a differential action among a first rotary element connected with the engine, a second rotary element connected with the motor, and a third rotary element;
wherein said any one of directions includes a rotational direction of the engine in a self-sustaining condition;
wherein the engagement piece includes a first engagement piece held in a first face of the fixed clutch plate, and a second engagement piece held in a second face the fixed clutch plate;
wherein the rotary clutch plate includes a first rotary clutch plate that is opposed to the first face and that has a first recess engaged with the first engagement piece, and a second rotary clutch plate that is opposed to the second face and that has a second recess engaged with the second engagement piece;
wherein the first rotary clutch plate is connected with an output shaft of the engine or a member integrated with the output shaft; and
wherein the second rotary clutch plate is connected with a rotary shaft of the motor or a member integrated with the rotary shaft.

7. The drive unit as claimed in claim 2,
wherein the differential includes
a first differential adapted to perform a differential action among the first rotary element connected with the engine, the second rotary element connected with the motor, and the third rotary element serving as an output element, and
a second differential adapted to perform a differential action among a fourth rotary element connected with the engine, a fifth rotary element connected with the motor, and a sixth rotary element that is stopped selectively; and
wherein the engagement piece includes a first engagement piece held in a first face of the fixed clutch plate, and a second engagement piece held in a second face of the fixed clutch plate;
wherein the rotary clutch plate includes a first rotary clutch plate that is opposed to the first face and that has a first recess engaged with the first engagement piece, and a second rotary clutch plate that is opposed to the second face and that has a second recess engaged with the second engagement piece;
wherein the first rotary clutch plate is connected with an output shaft of the engine or a member integrated with the output shaft; and
wherein the second rotary clutch plate is connected with the sixth rotary element or a member integrated with the sixth rotary element.

8. The drive unit as claimed in claim 6, wherein the first engagement piece and the second engagement piece are displaced from each other in the radial direction of the fixed clutch plate.

9. The drive unit as claimed in claim 7, wherein the first engagement piece and the second engagement piece are displaced from each other in the radial direction of the fixed clutch plate.
